(19) United States
(12) Patent Application Publication
(10) Pub. No.: US 2025/0348251 A1
(43) Pub. Date: Nov. 13, 2025

(54) INFORMATION PROCECSSING APPARATUS, INFORMATION DISPLAY SYSTEM, AND STORAGE MEDIUM

(71) Applicant: KONICA MINOLTA, INC., Tokyo (JP)

(72) Inventor: Hiroshi SHIMURA, Tokyo (JP)

(73) Assignee: KONICA MINOLTA, INC., Tokyo (JP)

(21) Appl. No.: 19/191,288

(22) Filed: Apr. 28, 2025

(30) Foreign Application Priority Data
May 8, 2024 (JP) 2024-075813

(51) Int. Cl. G06F 3/12

(52) U.S. Cl. CPC G06F 3/121; G06F 3/1234

(57) ABSTRACT

An information processing apparatus includes a hardware processor and an outputter. The hardware processor obtains jam occurrence-related information from each of printing apparatuses, and, from the obtained jam occurrence-related information, calculates, for each sheet feed tray of each of the printing apparatuses, a jam occurrence-related numerical value. The outputter outputs the calculated jam occurrence-related numerical value.

### CROSS-REFERENCE TO RELATED APPLICATIONS

The entire disclosure of Japanese Patent Application No. 2024-075813, filed on May 8, 2024, is incorporated herein by reference in its entirety.

### BACKGROUND OF THE INVENTION

### Technical Field

The present invention relates to an information processing apparatus, an information display system, and a storage medium.

### Description of Related Art

An administrator of a printing company owing a plurality of printing apparatuses decides which sheet feed tray of which printing apparatus to use to print an ordered job. At the time, the administrator considers various conditions such as improvement in quality, delivery deadline, and cost reduction. It is important to reduce the number of waste sheets during printing, giving consideration to such various conditions. Here, the “waste sheets” are sheets discarded due to a jam or the like.

For example, in the technology disclosed in Japanese Unexamined Patent Publication No. 2023-097596, in order to reduce the number of waste sheets, in a single printing apparatus, the number of times of jam occurrence for each sheet feed tray included in the printing apparatus is stored. Then, on the basis of the number of times of jam occurrence, on a display (display part) of the printing apparatus, what size of sheet should be set in which sheet feed tray is displayed. Thus, a recommended sheet feed tray is proposed to a user of the printing apparatus.

### SUMMARY OF THE INVENTION

However, the technology disclosed in Japanese Unexamined Patent Publication No. 2023-097596 merely proposes, in a single printing apparatus, a recommended sheet feed tray on a display (display part) of the printing apparatus. Therefore, in the case where a printing company owns a plurality of printing apparatuses, an administrator of the printing company cannot utilize the technology as it is to decide which sheet feed tray of which printing apparatus to use to print an ordered job.

The present invention has been made in consideration of the above-mentioned problems and situations. An object of the present invention is to provide an information processing apparatus, an information display system and a storage medium storing a program that allows an administrator of a printing company owning a plurality of printing apparatuses to efficiently and easily decide which sheet feed tray of which printing apparatus to use to print an ordered job.

To achieve at least one of the abovementioned objects, according to an aspect of the present invention, an information processing apparatus reflecting one aspect of the present invention includes:
a hardware processor that obtains jam occurrence-related information from each of printing apparatuses, and, from the obtained jam occurrence-related information, calculates, for each sheet feed tray of each of the printing apparatuses, a jam occurrence-related numerical value; and
an outputter that outputs the calculated jam occurrence-related numerical value.

According to an aspect of the present invention, an information display system reflecting one aspect of the present invention includes:
the information processing apparatus;
the printing apparatuses connected to the information processing apparatus and each including a sheet feed tray where a sheet is stored; and
a user terminal connected to the information processing apparatus and including a display,
wherein the user terminal switches jam occurrence-related numerical values, each of which is the jam occurrence-related numerical value, for the printing apparatuses to display, on the display, a jam occurrence-related numerical value of the jam occurrence-related numerical values for a printing apparatus of the printing apparatuses.

According to an aspect of the present invention, an information display system reflecting one aspect of the present invention includes:
the information processing apparatus;
the printing apparatuses connected to the information processing apparatus and each including a sheet feed tray where a sheet is stored; and
a user terminal connected to the information processing apparatus and including a display,
wherein the information processing apparatus derives, from the calculated jam occurrence-related numerical value, a sheet feed tray that is unlikely to cause a jam, and outputs information on the sheet feed tray, and
wherein the user terminal displays, on the display, the information on the sheet feed tray that is unlikely to cause a jam to be recognized by a user.

According to an aspect of the present invention, an information display system reflecting one aspect of the present invention includes:
the information processing apparatus;
the printing apparatuses connected to the information processing apparatus and each including a sheet feed tray where a sheet is stored; and
a user terminal connected to the information processing apparatus and including a display,
wherein in response to the information processing apparatus analyzing the jam occurrence-related information and determining that a first sheet feed tray that is unlikely to cause a jam is present for a sheet type, but the first sheet feed tray being (i) already used for a job currently being subjected to a printing process or (ii) scheduled to be used for a job to be subjected to the printing process, the information processing apparatus outputs information on a second sheet feed tray that is unlikely to cause a jam next to the first sheet feed tray, and
wherein the user terminal displays, on the display, information on the second sheet feed tray.

According to an aspect of the present invention, an information display system reflecting one aspect of the present invention includes:
the information processing apparatus;
the printing apparatuses connected to the information processing apparatus and each including a sheet feed tray where a sheet is stored; and
a user terminal connected to the information processing apparatus and including a display,
wherein in response to a previously executed job being to be executed again, the information processing apparatus analyzes job information on the previously executed job, preferentially selects a printing apparatus and/or a sheet feed tray used for the previously executed job, and outputs information on the printing apparatus and/or the sheet feed tray, and
wherein the user terminal preferentially displays, on the display, the information on the printing apparatus and/or the sheet feed tray.

According to an aspect of the present invention, a non-transitory computer-readable storage medium reflecting one aspect of the present invention stores a program causing a computer of an information processing apparatus to:
obtain jam occurrence-related information from each of printing apparatuses;
from the obtained jam occurrence-related information, calculate, for each sheet feed tray of each of the printing apparatuses, a jam occurrence-related numerical value; and
output the calculated jam occurrence-related numerical value.

### BRIEF DESCRIPTION OF THE DRAWINGS

The advantages and features provided by one or more embodiments of the invention will become more fully understood from the detailed description given hereinafter and the appended drawings which are given by way of illustration only, and thus are not intended as a definition of the limits of the present invention, and wherein:

FIG. 1 illustrates an example of a schematic configuration of an information display system of the present invention;

FIG. 2 illustrates an example of a schematic configuration of a printing apparatus according to the present invention;

FIG. 3 is a block diagram illustrating a functional configuration of a controller included in the printing apparatus according to the present invention;

FIG. 4 illustrates an example of a flowchart illustrating the flow of a first embodiment;

FIG. 5 illustrates an example of a display screen of a table of jam occurrence-related numerical values displayed on a display part of a user terminal in the first embodiment;

FIG. 6 illustrates an example of a flowchart illustrating the flow of a second embodiment;

FIG. 7 illustrates an example of a display screen of a table of jam occurrence-related numerical values displayed on the display part of the user terminal in the second embodiment;

FIG. 8 illustrates an example of a flowchart illustrating the flow of a third embodiment;

FIG. 9 illustrates an example of a display screen of a table of jam occurrence-related numerical values displayed on the display part of the user terminal in the third embodiment;

FIG. 10 illustrates an example of a flowchart illustrating the flow of a fourth embodiment;

FIG. 11 illustrates an example of a display screen of a table of jam occurrence-related numerical values displayed on the display part of the user terminal in the fourth embodiment;

FIG. 12 illustrates an example of a flowchart illustrating the flow of a fifth embodiment; and

FIG. 13 illustrates an example of a display screen of a table of jam occurrence-related numerical values displayed on the display part of the user terminal in the fifth embodiment.

### DETAILED DESCRIPTION

Hereinafter, an information processing apparatus, an information display system, and a storage medium storing a program(s) according to embodiments of the present invention will be described in detail with reference to the drawings. However, the scope of the invention is not limited to the illustrated examples. In the following description, components having the same function(s) and configuration are denoted by the same reference sign, and the description thereof will be omitted.

The advantages and features provided by one or more embodiments of the present invention will be more fully understood from the following detailed description and the appended drawings, which are intended for purposes of illustration only. Therefore, these are not intended to define the limits of the present invention.

### Information Display System

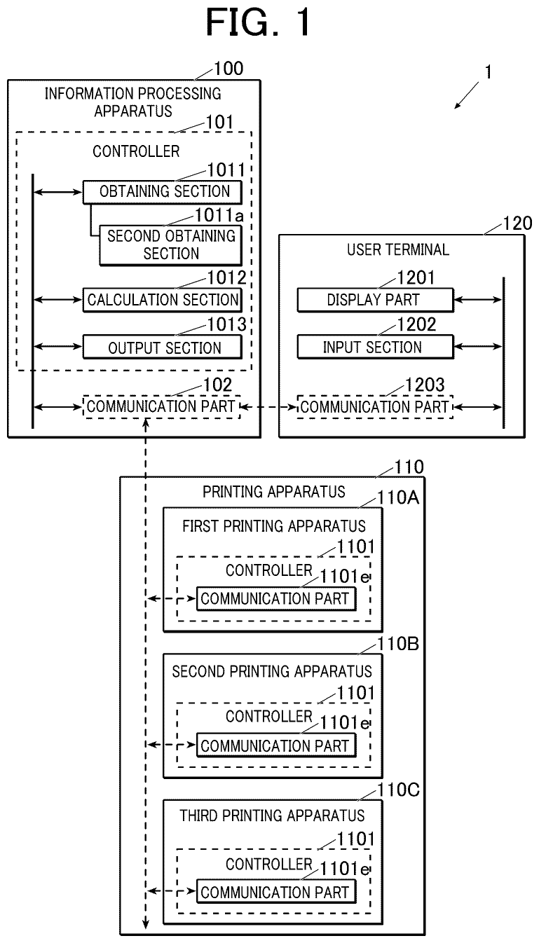

FIG. 1 illustrates an example of a schematic configuration of an information display system of the present invention. The information display system 1 of the present invention includes an information processing apparatus 100, a plurality of printing apparatuses 110, and a user terminal 120.

The printing apparatuses include, for example, a first printing apparatus 110A, a second printing apparatus 110B, and a third printing apparatus 110C.

### (Printing Apparatus)

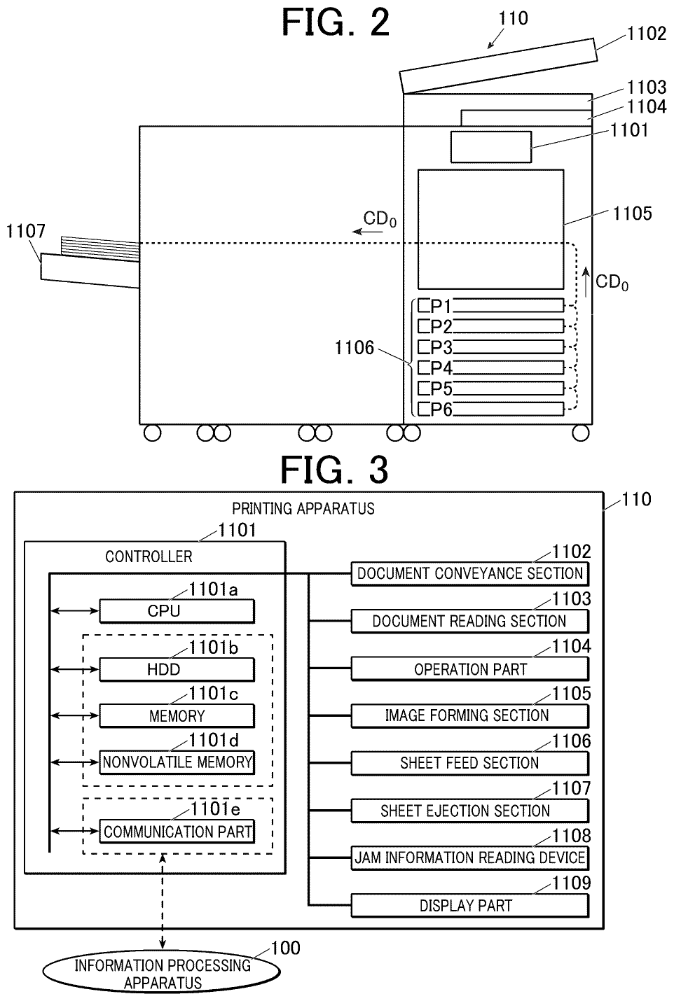

FIG. 2 illustrates an example of a schematic configuration of a printing apparatus according to the present invention. FIG. 3 is a block diagram that illustrates a functional configuration of a controller included in the printing apparatus according to the present invention.

A printing apparatus 110 mainly includes a controller 1101, a document conveyance section 1102, a document reading section 1103, an operation part 1104, an image forming section 1105, a sheet feed section 1106, a sheet ejection section 1107, a jam information reading device 1108, and a display part 1109.

The printing apparatus 110 may be provided with an image reading section (not illustrated) to read a print image formed by the image forming section 1105 to obtain print image information such as coverage (coverage rate) information, which may be used as jam occurrence-related information. The image reading section (not illustrated) is included in the jam information reading device 1108.

### Controller

The controller 1101 mainly controls components such as a CPU 1101a, an HDD 1101b, a memory 1101c, a nonvolatile memory 1101d, and a communication part 1101e. The CPU 1101a, the HDD 1101b, the memory 1101c, the nonvolatile memory 1101d, and the like are connected via a bus. The controller 1101 has a function as an image processor that analyzes job information received from the communication part 1101e and generates image information for forming a print image.

The CPU 1101a performs control of each component, image processing, and the like.

The HDD 1101b stores programs for the CPU 1101a to control each component, information on processing functions of the apparatus, and job information received from the jam information reading device 1108, the document reading section 1103, and the communication part 1101e. These programs, information, and job information are read by the CPU 1101a as necessary, and are executed on the memory 1101c.

The memory 1101c temporarily stores job information and various kinds of data. The stored job information and various kinds of data are processed by the CPU 1101a and transferred to the image forming section 1105. The print data is rasterized on the memory, and bitmap data of each color of YMCK for printing is generated.

The communication part 1101e is connected to a network via a LAN cable or the like, establishes a connection with the information processing apparatus 100 or the like, and performs data transmission and reception of job information, various statuses, and the like. In addition, the communication part 1101e functions as an output section that outputs jam occurrence-related information read by the jam information reading device 1108.

### Jam Information Reading Device

The jam information reading device 1108 obtains the number of times of printing, the number of times of jam occurrence for each sheet feed tray, the type of sheet, coverage (coverage rate) information set in the printing apparatus, and temperature-humidity information in the printing apparatus.

The jam occurrence-related information obtained by the jam information reading device 1108 is output by the controller 1101 and transmitted to the information processing apparatus 100 via the communication part 1101e.

Examples of the “jam occurrence-related information” include not only the number of times of printing in the printing apparatus 110 and the number of times of jam occurrence for each sheet feed tray, but also the type of sheet that affects jam occurrence, the coverage (coverage rate) information set in the printing apparatus, the temperature-humidity information in the printing apparatus, and the like.

Examples of the “type of sheet” include the sheet quality (sheet brand), basis weight, sheet weight, and sheet size.

Examples of the “jam occurrence-related information” further include information on each sheet feed tray for a job that is already executed or reserved. Examples of the “jam occurrence-related information” further include job information previously executed by the printing apparatus 110.

When the information processing apparatus 100, which will be described later, obtains jam occurrence-related information from the printing apparatus 110 with the operation of a controller 101 (hardware processor), the information processing apparatus 100 obtains the information read by the jam information reading device 1108.

### Document Conveyance Section, Document Reading Section, Operation Part and Display Part

The document conveyance section 1102 automatically conveys one or a plurality of document sheets to the document reading section 1103. The document reading section 1103 optically reads image information from a document sheet on a document plate.

The operation part 1104 is used when a user performs various kinds of setting related to the printing apparatus 110. The operation part 1104 is a touch screen and is configured to be able to process screen display on the display part 1109 and input operations on the operation part in parallel. This operation function may be provided not on the panel but anywhere as long as the operation function can be provided.

### Image Forming Section

The image forming section 1105 includes a photosensitive drum, a transfer roller, a developing device, and a fixing device. In the present specification, the term “image forming section” is a general term for constituent elements necessary for forming an image in an image forming system using an image forming process such as an electrophotographic method or an electrostatic recording method.

The controller 1101 forms a print image on the sheet conveyed from the sheet feed section 1106 on the basis of the job information. Then, the sheet is fed to the sheet ejection section 1107 in a sheet channel CD₀.

### Sheet Feed Section

The sheet feed section 1106 is a section for storing sheets and includes a part for sending the stored sheets to the image forming section 1105. The sheet feed section 1106 includes sheet feed trays 1 to 6 that store sheets. In FIG. 2, the sheet feed trays 1, 2, 3, 4, 5 and 6 are indicated by P1, P2, P3, P4, P5 and P6, respectively.

In FIG. 2, the sheet feed section 1106 is composed of six sheet feed trays, but the configuration of the sheet feed section 1106 included in the printing apparatus 110 according to the present invention is not limited thereto, and it may be composed of one or a plurality of sheet feed trays.

### Sheet Ejection Section

The sheet ejection section 1107 ejects and stacks print products. The controller 1101 ejects, to the sheet ejection section 1107, a sheet or the like with an image printed by the image forming section 1105.

### (Information Processing Apparatus)

The information processing apparatus 100 of the present invention includes a communication part 102 that can communicate information with the printing apparatus 110 and the user terminal 120, and a controller 101 that performs various processes (see FIG. 1).

The controller 101 includes a CPU, a RAM, and a ROM, and functions as an obtaining section that obtains jam occurrence-related information for each sheet feed tray from each of the printing apparatuses 110 via the communication part 102.

Furthermore, the controller 101 functions as a second obtaining section that obtains the type of sheet in a case where the jam occurrence-related information is the type of sheet.

More specifically, the controller 101 obtains jam occurrence-related information from each of the printing apparatuses 110. Furthermore, the controller 101 obtains job information input to the input section 1202 of the user terminal 120 or the printing apparatus 110.

A case where the jam occurrence-related information is, for each sheet feed of a printing apparatus, the number of times of printing tray and the number of times of jam occurrence will be described with a specific example.

For example, it is assumed that printing was performed 1000 times with the sheet feed tray 1, 800 times with the sheet feed tray 2, 300 times with the sheet feed tray 3, and 100 times with each of the sheet feed trays 4 to 6 of the first printing apparatus 110A.

It is also assumed that in the first printing apparatus 110A, the jam occurred 40 times with the sheet feed tray 1, occurred 16 times with the sheet feed tray 2, did not occur with the sheet feed tray 3, and occurred once with each of the sheet feed trays 4 to 6.

This information on the number of times of jam occurrence for each sheet feed tray is the jam occurrence-related information.

The information processing apparatus 100 of the present invention obtains the number of times of jam occurrence for each sheet feed tray of not a single printing apparatus 100 but each of the printing apparatuses 110.

Therefore, unlike the above example, the jam occurrence-related information includes the number of times of printing for each sheet feed tray and the number of times of jam occurrence for each sheet feed tray in not only the first printing apparatus 110A but also the second printing apparatus 110B and the third printing apparatus 110C, for example.

Furthermore, the controller 101 functions as a calculation section that analyzes the obtained jam occurrence-related information and calculates a jam occurrence-related numerical value for each sheet feed tray of each of the plurality of printing apparatuses 110.

The controller 101 analyzes the jam occurrence-related information described above and calculates the jam occurrence-related numerical value for each sheet feed tray.

For example, the controller 101 analyzes, for each sheet feed tray of each of the printing apparatuses, the number of times of printing and the number of times of jam occurrence and information on a sheet type, and calculates, for each sheet feed tray of each of the printing apparatuses, a jam nonoccurrence probability for the sheet type.

In the present invention, the jam occurrence-related information is obtained by the information processing apparatus 100 from not one printing apparatus but each of the printing apparatuses 110.

However, for simplicity, a method for the information processing apparatus 100 to analyze the jam occurrence-related information on the first printing apparatus 110A and calculate the jam occurrence-related numerical value thereof will be described.

The method for calculating the jam occurrence-related numerical value of each of the printing apparatuses other than the first printing apparatus 110A is the same as the method for calculating the jam occurrence-related numerical value of the first printing apparatus 110A. Furthermore, in the information processing apparatus 100 of the present invention, the calculation of the jam occurrence-related numerical value of each of the other printing apparatuses is performed simultaneously with that of the first printing apparatus 110A.

A case where the jam occurrence-related information is the number of times of printing for each sheet feed tray and the number of times of jam occurrence for each sheet feed tray of the printing apparatus will be described with a specific example.

A method for calculating the jam occurrence-related numerical value in the aforementioned case, where printing was performed 1000 times with the sheet feed tray 1, 800 times with the sheet feed tray 2, 300 times with the sheet feed tray 3, and 100 times with each of the sheet feed trays 4 to 6 of the first printing apparatus 110A, will be described. The number of times of jam occurrence for each sheet feed tray is the same as that described above.

In the following description, the “jam occurrence-related numerical value” is the “jam nonoccurrence probability”, but not limited thereto, and therefore, for example, may be the “jam occurrence probability”.

The jam occurred 40 times in printing of 1000 sheets in the sheet feed tray 1, occurred 16 times in printing of 800 sheets in the sheet feed tray 2, did not occur in printing of 300 sheets in the sheet feed tray 3, and occurred once in printing of 100 sheets in each of the sheet feed trays 4 to 6. The controller 101 calculates the jam occurrence probability for each sheet feed tray in consideration of the number of times of jam occurrence and the number of times of printing with each sheet feed tray.

For example, with the sheet feed tray 1, the jam occurred 40 times with respect to 1000 times as the number of times of printing, the controller 101 calculates the jam occurrence probability for the sheet feed tray 1 as follows: (40/1000)×100=4%.

The controller 101 calculates the jam occurrence probability for each sheet feed tray as described above, and subtracts the jam occurrence probability from 100%, thereby calculating the jam nonoccurrence probability for each sheet feed tray. In the above example, the jam nonoccurrence probability of the sheet feed tray 1 of the first printing apparatus 110A is 100%-4%=96%.

The jam nonoccurrence probability for each of the sheet feed trays calculated by the controller 101 is 96% for the sheet feed tray 1, 98% for the sheet feed tray 2, 100% for the sheet feed tray 3, and 99% for the sheet feed trays 4 to 6.

The above jam occurrence-related numerical values calculated by the controller 101 are stored by the controller 101. The controller 101 also stores the jam occurrence-related information other than the jam occurrence-related numerical values. In this sense, the controller 101 functions as a storage section.

The communication part 102 functions as an output section (outputter) that outputs the jam occurrence-related numerical value for each sheet feed tray of each of the printing apparatuses 110 calculated by the controller 101.

The communication part 102 outputs the jam occurrence-related numerical value for each sheet feed tray. Since the jam occurrence-related information other than the jam occurrence-related numerical value(s) is also stored in the information processing apparatus 100, the communication part 102 may transmit the jam occurrence-related information to the user terminal 120.

The communication part 102 also plays a role of outputting the job information obtained by the controller 101 and transmitting it to the printing apparatuses 110.

The information processing apparatus 100 stores the jam occurrence-related information. Hereinafter, it is assumed that the “jam occurrence-related information” includes information stored in the information processing apparatus 100 by being input in advance through the input section 1202 of the user terminal 120.

The information processing apparatus 100 can output, to the user terminal 120, jam occurrence-related numerical values for sheet types in a pre-registered sheet type candidate list. Furthermore, the user terminal 120 displays the candidate list on a display part to present options to the user.

The “sheet type candidate list” is, for example, a list in which pieces of information on jam occurrence-related numerical values calculated for the respective sheet feed trays are organized/arranged by sheet type.

For example, in a case where the sheet type is the sheet size, there are three types of sheet size in the list of sheet type candidates, and they are A4, A3, and B4.

The jam nonoccurrence probabilities for the sheet feed trays 1 to 6 of the first printing apparatus 110A, the second printing apparatus 110B and the third printing apparatus 110C are listed for the sheet sizes A4, A3, and B4, respectively.

As an example of the list, FIG. 5 illustrates a display screen of a table of jam occurrence-related numerical values displayed on the display part of the user terminal in a first embodiment described later.

It is considered that the jam nonoccurrence probability for each sheet feed tray of each printing apparatus is usually different depending on the sheet size, namely, A4, A3, or B4.

Therefore, by displaying a list of sheet size candidates on a display part 1201 (display), options by sheet size can be presented to the user. This makes it easy for the user to decide which sheet feed tray is suitable for which sheet size.

The list of candidates registered and stored in the information processing apparatus 100 is not limited to the list of sheet type candidates, and may be a list of candidates selected from the jam occurrence-related information.

In a case where the list of candidates is a list of coverage (coverage rate) candidates, jam occurrence-related numerical values for the respective sheet feed trays for the respective coverages are listed and displayed on the user terminal 120.

For example, there are three types of coverage (coverage rate) in a coverage (coverage rate) candidate list, and the respective types are a coverage of 10%, a coverage of 30%, and a coverage of 50%.

The jam occurrence-related numerical values for the sheet feed trays 1 to 6 of the first printing apparatus 110A, the second printing apparatus 110B and the third printing apparatus 110C for the coverages of 10%, 30%, and 50% are listed.

To be specific, the list notation is such that the “A4” as a sheet size in FIG. 5, which is an example of a display screen of a table of jam occurrence-related numerical values displayed on the display part 1201 of the user terminal 120 in the first embodiment described later, is replaced by, for example, “Coverage of 10%”. Similarly, the “A3” therein is replaced by, for example, “Coverage of 30%” and the “B4” therein is replaced by, for example, “Coverage of 50%”. The jam nonoccurrence probabilities in FIG. 5 are due to the coverage (coverage rate) candidate list, and therefore merely numerical values for reference.

It is considered that the jam nonoccurrence probability for each sheet feed tray of each printing apparatus is usually different depending on the coverage, namely, a coverage of 10%, a coverage of 30% or a coverage of 50%.

Therefore, by displaying a list of coverage candidates and jam nonoccurrence probabilities related to the coverages in the list of coverage candidates on the display part, options by coverage can be presented to the user. Thus, the user can easily decide which sheet feed tray of which printing apparatus is suitable for which coverage.

For example, there are three types of temperature-humidity information in a temperature-humidity information candidate list, and the respective types are temperature-humidity information A (25° C. and 10% RH), temperature-humidity information B (15° C. and 20% RH), and temperature-humidity information C (30° C. and 30% RH).

The jam nonoccurrence probabilities for the sheet feed trays 1 to 6 of the first printing apparatus 110A, the second printing apparatus 110B and the third printing apparatus 110C for the temperature-humidity information A, the temperature-humidity information B and the temperature-humidity information C are listed.

To be specific, the list notation is such that the “A4” as a sheet size in FIG. 5, which is an example of a display screen of a table of jam occurrence-related numerical values displayed on the display part 1201 of the user terminal 120 in the first embodiment described later, is replaced by, for example, “Temperature-Humidity Information A (25° C. and 10% RH”). Similarly, the “A3” therein is replaced by, for example, “Temperature-Humidity Information B (15° C. and 20% RH)”, and the “B4” is replaced by, for example, “Temperature-Humidity Information C (30° C. and 30% RH)”. The jam nonoccurrence probabilities in FIG. 5 are due to the temperature-humidity information candidate list, and therefore merely numerical values for reference.

It is considered that the jam nonoccurrence probability for each sheet feed tray of each printing apparatus is usually different depending on the temperature-humidity information, namely, the temperature-humidity information A, the temperature-humidity information B or the temperature-humidity information C.

Therefore, by displaying a list of temperature-humidity information candidates on the display part, options can be presented to the user. This makes it easy for the user to decide which sheet feed tray of which printing apparatus is suitable for which temperature-humidity information.

### (User Terminal)

The user terminal 120 includes a display part 1201, an input section 1202, and a communication part 1203. The user terminal 120 receives, via the communication part 1203, the jam occurrence-related information output by the controller 101 of the information processing apparatus 100 and transmitted to the user terminal 120. Then, in accordance with an instruction input by the administrator to the input section 1202, the jam occurrence-related information is displayed together with the jam occurrence-related numerical value on the display part 1201.

When the jam occurrence-related information is the jam occurrence-related numerical value for each sheet type, the user terminal 120 displays the jam occurrence-related numerical value for each sheet type on the display part 1201 for each printing apparatus and/or for each sheet feed tray.

### [1] First Embodiment

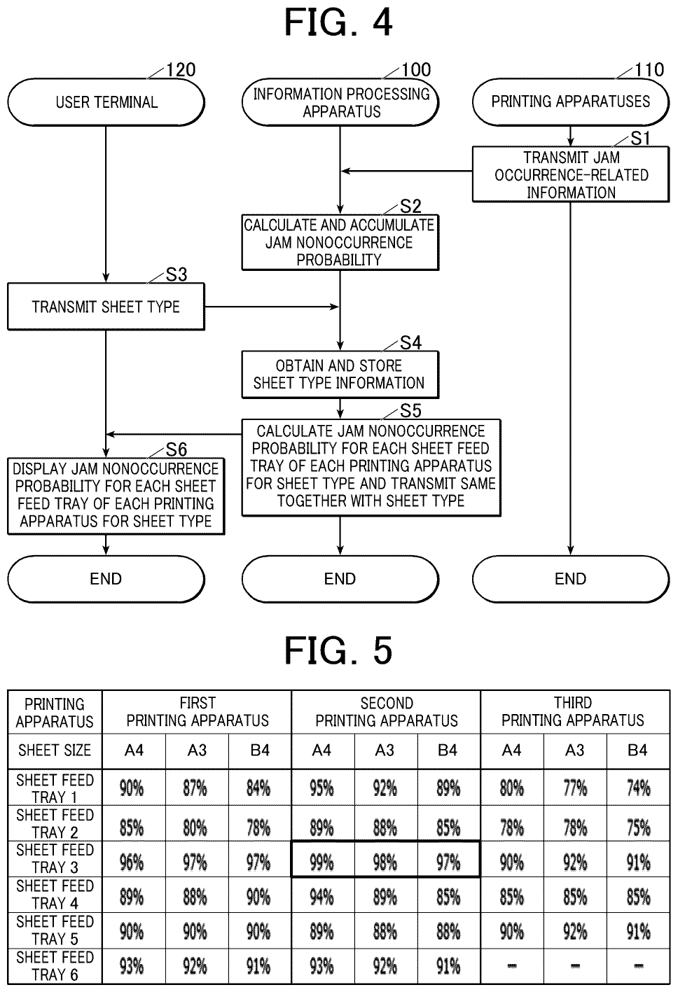

FIG. 4 illustrates an example of a flowchart which illustrates the flow of a first embodiment.

A case will be described where a coated sheet is decided in advance as a sheet type to be used in printing of an ordered job.

In Step S1, the printing apparatus(es) 110 starts printing. The jam occurrence-related information is transmitted from the printing apparatus 110 to the information processing apparatus 100 via the communication part 1101e. At the time, the job information executed in the printing apparatus 110 is also transmitted. The jam occurrence-related information is, for example, the number of times of printing with/for each sheet feed tray of each printing apparatus.

In Step S2, the controller 101 of the information processing apparatus 100 calculates the jam occurrence-related numerical value(s) from the jam occurrence-related information. Then, the controller 101 stores the job information, the jam occurrence-related information, and the information on the jam occurrence-related numerical value(s).

These pieces of information are updated and accumulated every time the information processing apparatus 100 obtains new pieces of information. When obtaining a piece of the jam-related information, the controller 101 uses the updated accumulated information to calculate the jam occurrence-related numerical value(s). The jam occurrence-related numerical value is, for example, the jam nonoccurrence probability.

When a sheet type to be used in printing is decided, the administrator inputs the sheet type in a job to the input section 1202 of the user terminal 120.

In Step S3, the user terminal 120 transmits the input sheet type information to the information processing apparatus 100 via the communication part 1203.

In Step S4, the controller 101 of the information processing apparatus 100 obtains the input sheet type information via the communication part 102, and stores the information in a storage section (not illustrated).

The jam nonoccurrence probability for each sheet feed tray of each printing apparatus is calculated for the sheet type by the calculation section 1012.

The jam information reading device is not particularly limited, but is, for example, a media sensor.

In Step S5, the controller 101 of the information processing apparatus 100 calculates the jam nonoccurrence probability for each sheet feed tray for the newly stored sheet type information from the jam nonoccurrence probability for each sheet feed tray of each printing apparatus.

That is, regarding coated sheets, the controller 101 calculates the jam nonoccurrence probability for each sheet feed tray of each printing apparatus.

Then, the jam nonoccurrence probabilities are transmitted to the user terminal 120 together with the sheet type information via the communication part 102.

In Step S6, the user terminal 120 receives the jam nonoccurrence probabilities transmitted from the information processing apparatus 100 via the communication part 1203, and displays the jam nonoccurrence probabilities on the display part 1201 of the user terminal 120.

### (Specific Example of First Embodiment)

FIG. 5 illustrates an example of a display screen of a table of jam occurrence-related numerical values displayed on the display part of the user terminal in the first embodiment.

In FIG. 5, the sheet feed trays 1 to 6 are the sheet feed trays provided in the sheet feed section 1106 included in each printing apparatus. In FIG. 5, the same number of sheet feed trays are displayed as being included in each printing apparatus, but the printing apparatuses may not be provided with the same number of sheet feed trays in the present embodiment. Furthermore, the number of sheet feed trays is not limited to six, but may be one.

In FIG. 5, a value of a percentage [%] displayed in the table represents a jam nonoccurrence probability. In FIG. 5, the jam nonoccurrence probabilities for the respective sheet feed trays of each printing apparatus are listed. The list display may be a dashboard.

In FIG. 5, “-” is displayed for the sheet feed tray 6 included in the third printing apparatus 110C. This

indicates that the sheet feed tray 6 included in the third printing apparatus 110C has not been used for printing on coated sheets. This also indicates that regarding the sheet feed tray 6, no information on coated sheets is registered in previous print information on printing companies or the like other than the user and in the information processing apparatus 100.

As a tip, the sheet feed tray 3 of the second printing apparatus 110B among the printing apparatuses 110 connected to the information processing apparatus 100 is displayed as a recommended sheet feed tray on the display part 1201 of the user terminal 120.

In FIG. 5, the jam nonoccurrence probabilities for the respective sheet sizes in the recommended sheet feed tray are enclosed by a thick frame. The sheet feed tray 3 of the second printing apparatus 110B being the recommended sheet feed tray may be displayed in words on the display part 1201 of the user terminal 120.

Instead of displaying the jam nonoccurrence probabilities for the respective sheet feed trays of each printing apparatus in the form of a list on the display part 1201 of the user terminal 120 as in FIG. 5, the jam nonoccurrence probabilities regarding, for example, the first printing apparatus 110A only may be displayed in the form of a list.

The display screen of the display part 1201 may be in a display form in which the type of printing apparatus is switchable, for example, by displaying, in a list, the jam nonoccurrence probabilities regarding the second printing apparatus 110B only or displaying, in a list, the jam nonoccurrence probabilities regarding the third printing apparatus 110C only.

There may be a case where immediately after printing is started, the printing is performed with sheets set on the sheet feed trays included in each printing apparatus regardless of the priority of the sheet feed trays. Therefore, the display screen as illustrated in FIG. 5 may be displayed on the user terminal again after the jam occurs during printing.

In the first embodiment, the display part 1201 of the user terminal 120 displays, about coated sheets, the jam nonoccurrence probabilities for the respective sheet sizes in the form of a list.

The jam nonoccurrence probabilities to be displayed are not limited to those for respective sheet sizes, but may be those for any other jam occurrence-related information.

### [2] Second Embodiment

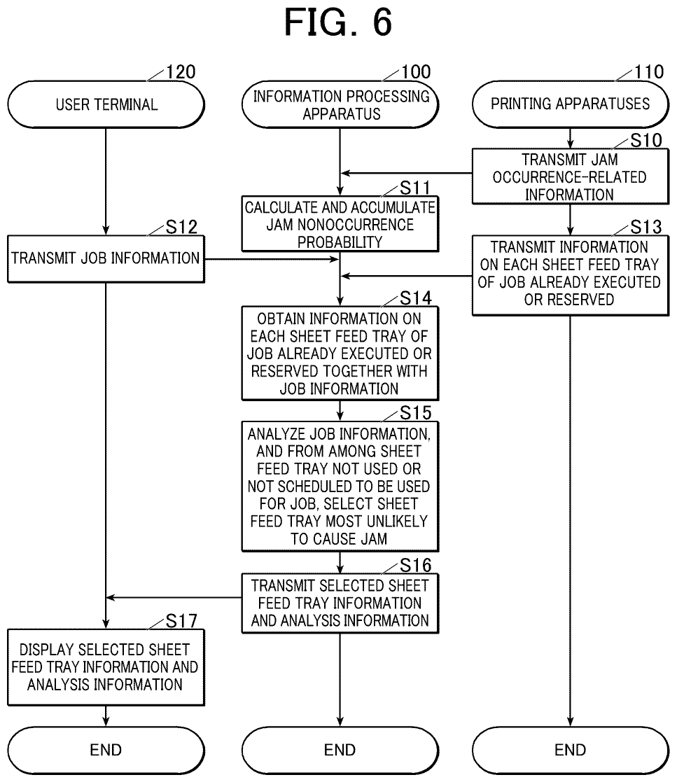

FIG. 6 illustrates an example of a flowchart illustrating the flow of a second embodiment.

A case where when an ordered job is to be executed, job(s) are already executed or reserved in the printing apparatuses 110 connected to the information processing apparatus 100 will be described.

In Step S10, the printing apparatus(es) 110 starts printing. The jam occurrence-related information is transmitted from the printing apparatus 110 to the information processing apparatus 100 via the communication part 1101e. At the time, the job information being executed in the printing apparatus 110 is also transmitted. The jam occurrence-related information is, for example, the number of times of printing with/for each sheet feed tray of each printing apparatus.

In Step S11, the controller 101 of the information processing apparatus 100 calculates the jam occurrence-related numerical value(s) from the jam occurrence-related information. Then, the controller 101 stores the job information, the jam occurrence-related information, and the information on the jam occurrence-related numerical value(s).

These pieces of information are updated and accumulated every time the information processing apparatus 100 obtains new pieces of information. When obtaining a piece of the jam-related information, the controller 101 uses the updated accumulated information to calculate the jam occurrence-related numerical value(s). The jam occurrence-related numerical value is, for example, the jam nonoccurrence probability.

When a job(s) is already executed or reserved in the printing apparatuses 110, the administrator inputs the job information to the input section 1202 of the user terminal 120.

In Step S12, the user terminal 120 transmits the input job information to the information processing apparatus 100.

In Step S13, the controller 1101 of each of the printing apparatuses 110 transmits, to the information processing apparatus 100, information on each sheet feed tray of a job(s) already executed or reserved.

In Step S14, the controller 101 of the information processing apparatus 100 obtains and stores the input job information. The information processing apparatus 100 also obtains the information on each sheet feed tray of the job already executed or reserved, and stores the information in the storage section (not illustrated).

In Step S15, the controller 101 of the information processing apparatus 100 analyzes the information on each sheet feed tray of the job already executed or reserved in each printing apparatus. Then, each sheet feed tray of each printing apparatus being not used or not scheduled to be used for a job is derived, and the information is stored.

Then, by performing comparison with the jam occurrence-related information stored in advance in the information processing apparatus 100, the controller 101 selects, from among the sheet feed trays not being used or not scheduled to be used for a job, a sheet feed tray that is most unlikely to cause a jam.

In Step S16, the controller 101 of the information processing apparatus 100 transmits, to the user terminal 120, analysis information including information on the selected sheet feed tray that is most unlikely to cause a jam among the sheet feed trays not being used or not scheduled to be used for a job.

In Step S17, the user terminal 120 receives the analysis information and the information on the selected sheet feed tray calculated by the information processing apparatus 100. Then, the information on the selected sheet feed tray and the analysis information are displayed on the display part 1201 included in the user terminal 120 together with the jam occurrence-related numerical values.

### (Specific Example of Second Embodiment)

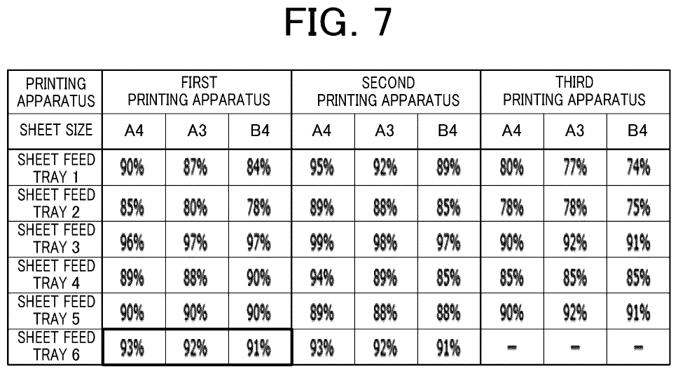

FIG. 7 illustrates an example of a display screen of a table of jam occurrence-related numerical values displayed on the display part of the user terminal in the second embodiment.

The user terminal 120 displays, on the display part 1201, a list of jam nonoccurrence probabilities for the respective sheet feed trays of each printing apparatus, as illustrated in FIG. 7. In addition, as a tip, on the display part 1201 of the user terminal 120, the jam nonoccurrence probabilities for the respective sheet sizes for the sheet feed tray 6 of the first printing apparatus 110A are displayed by being enclosed by a thick frame to indicate that the sheet feed tray 6 of the first printing apparatus 110A is the recommended sheet feed tray when sheet feed trays scheduled to be used are avoided.

### [3] Third Embodiment

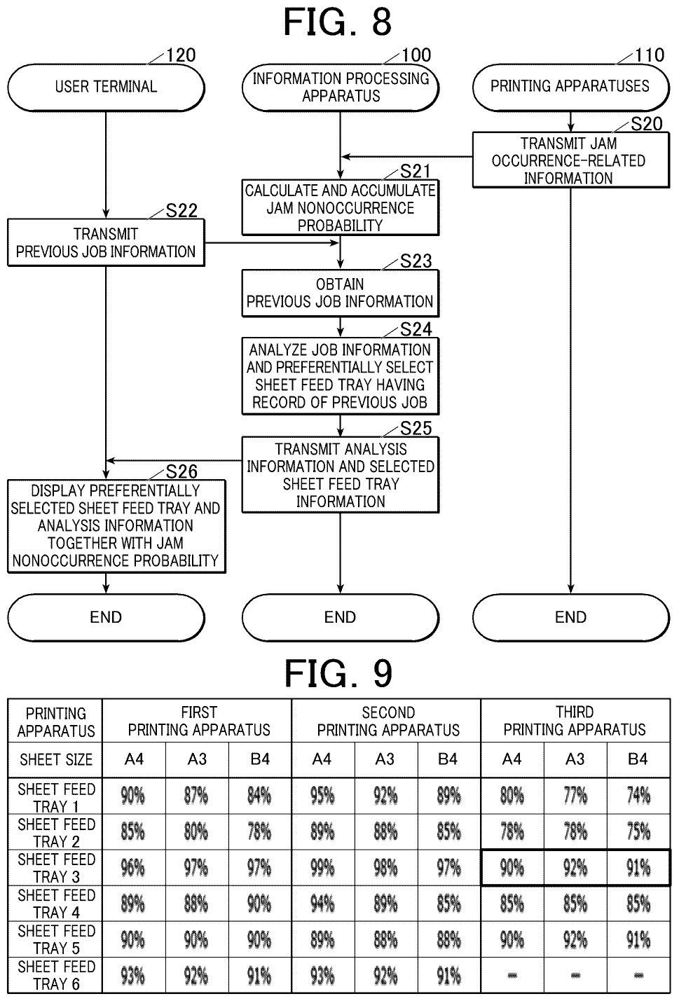

FIG. 8 illustrates an example of a flowchart illustrating the flow of a third embodiment.

A case where a job previously ordered and executed is executed again will be described. Hereinafter, the “job previously ordered and executed” is simply referred to as the “previous job”.

In Step S20, the printing apparatus(es) 110 starts printing. The jam occurrence-related information is transmitted from the printing apparatus 110 to the information processing apparatus 100 via the communication part 1101e. At the time, the job information executed in the printing apparatus 110 is also transmitted. The jam occurrence-related information is, for example, the number of times of printing with/for each sheet feed tray of each printing apparatus.

In Step S21, the controller 101 of the information processing apparatus 100 calculates the jam occurrence-related numerical value(s) from the jam occurrence-related information. Then, the controller 101 stores the job information, the jam occurrence-related information, and the information on the jam occurrence-related numerical value(s).

These pieces of information are updated and accumulated every time the information processing apparatus 100 obtains new pieces of information. When obtaining a piece of the jam-related information, the controller 101 uses the updated accumulated information to calculate the jam occurrence-related numerical value(s). The jam occurrence-related numerical value is, for example, the jam nonoccurrence probability.

The administrator inputs the previous job information to the input section 1202 of the user terminal 120.

In Step S22, the user terminal 120 transmits the input job information to the information processing apparatus 100.

In Step S23, the controller 101 of the information processing apparatus 100 obtains the previous job information via the communication part 102.

In Step S24, the controller 101 of the information processing apparatus 100 analyzes the obtained previous job information, and preferentially selects a sheet feed tray of a printing apparatus having the record of the previous job over the other sheet feed trays.

In Step S25, the controller 101 of the information processing apparatus 100 transmits the information on the selected sheet feed tray and the analysis information to the user terminal 120.

In Step S26, the user terminal 120 displays, on the display part 1201, the analysis information and the preferentially selected sheet feed tray together with the jam nonoccurrence probabilities. Then, as a tip, the recommended sheet feed tray is displayed on the display part 1201 of the user terminal 120.

Information that the priority has been given to the printing apparatus that has executed the job in the past is displayed as a tip on the display part 1201 of the user terminal 120.

When sheet feed trays of one printing apparatus have the same jam nonoccurrence probability, the user terminal 120 may display, on the display part 1201, as a tip, information that a sheet feed tray in which more sheets can be set is recommended.

In the present embodiment, it is possible that a job date is registered, or a job name is decided instead of the date, and the job date or the job name is input to the input section 1202 of the user terminal 120, transmitted to the information processing apparatus 100, and registered therein.

### (Specific Example of Third Embodiment)

FIG. 9 illustrates an example of a display screen of a table of jam occurrence-related numerical values displayed on the display part of the user terminal in the third embodiment.

When the administrator inputs, for example, a date of a previous job as the previous job information to the input section 1202 of the user terminal 120, the controller 101 of the information processing apparatus 100 obtains the date of the previous job via the communication part 102.

The controller 101 of the information processing apparatus 100 analyzes the obtained date of the job and preferentially selects a sheet feed tray of a printing apparatus having the record of the previous job execution over the other sheet feed trays.

Then, the controller 101 of the information processing apparatus 100 transmits the analysis information and the information on the selected sheet feed tray to the user terminal via the communication part. The user terminal 120 displays the recommended sheet feed tray on the display part 1201 as a tip to propose it to the administrator.

In FIG. 9, the jam nonoccurrence probabilities for the respective sheet sizes for the sheet feed tray 3 of the third printing apparatus 110C are displayed by being enclosed by a thick frame to indicate that the sheet feed tray 3 of the third printing apparatus 110C is the recommended sheet feed tray, on the display part 1201 of the user terminal 120.

It is possible that a job name of the previous job has been decided in advance and registered in the information processing apparatus 100 or the printing apparatus so that the job name is input to the input section 1202 of the user terminal 120 instead of the above-described date and the recommended sheet feed tray is displayed on the display part.

The display part 1201 of the user terminal 120 displays, as a tip, the information that the priority has been given to the printing apparatus that has the record of the previous job execution.

When sheet feed trays of one printing apparatus have the same jam nonoccurrence probability, the user terminal 120 may display, on the display part 1201, as a tip, information that a sheet feed tray in which more sheets can be set is recommended, as illustrated in FIG. 9.

### [4] Fourth Embodiment

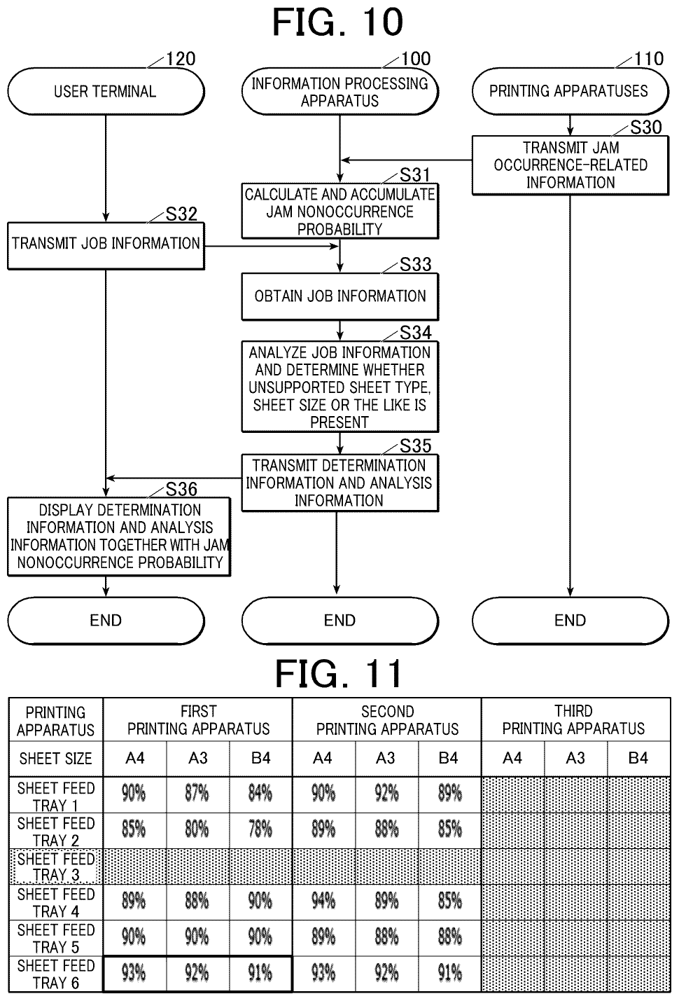

FIG. 10 illustrates an example of a flowchart illustrating the flow of a fourth embodiment.

A case where when an ordered job is executed, an unsupported sheet type, sheet size, or the like is present depending on the type of printing apparatus or the sheet feed tray.

In Step S30, the printing apparatus(es) 110 starts printing. The jam occurrence-related information is transmitted from the printing apparatus 110 to the information processing apparatus 100 via the communication part 1101e. At the time, the job information executed in the printing apparatus 110 is also transmitted. The jam occurrence-related information is, for example, the number of times of printing with/for each sheet feed tray of each printing apparatus.

In Step S31, the controller 101 of the information processing apparatus 100 calculates the jam occurrence-related numerical value(s) from the jam occurrence-related information. Then, the controller 101 stores the job information, the jam occurrence-related information, and the information on the jam occurrence-related numerical value(s).

These pieces of information are updated and accumulated every time the information processing apparatus 100 obtains new pieces of information. When obtaining a piece of the jam-related information, the controller 101 uses the updated accumulated information to calculate the jam occurrence-related numerical value(s). The jam occurrence-related numerical value is, for example, the jam nonoccurrence probability.

The administrator inputs the job information to the input section 1202 of the user terminal 120.

In Step S32, the user terminal 120 transmits the job information to the information processing apparatus 100 via the communication part 1203.

In Step S33, the controller 101 of the information processing apparatus 100 obtains the job information via the communication part 102.

In Step S34, the controller 101 of the information processing apparatus 100 analyzes the obtained job information. Then, the controller 101 determines whether an unsupported sheet type, sheet size, or the like is present depending on the type of each printing apparatus and the sheet feed tray, and stores the determination information. The information processing apparatus 100 stores the analysis information obtained by analyzing the job information.

In Step S35, the controller 101 of the information processing apparatus 100 transmits the determination information and the analysis information to the user terminal 120 via the communication part 102.

In Step S36, the user terminal 120 displays, on the display part 1201, the determination information and the analysis information received via the communication part 1203 together with the jam nonoccurrence probabilities. Then, the user terminal 120 proposes, to the administrator, a type(s) of printing apparatus and a sheet feed tray(s) having an unsupported sheet type, sheet size, or the like by performing masking display on the display part 1201 of the user terminal 120, as a tip.

### (Specific Example of Fourth Embodiment)

FIG. 11 illustrates an example of a display screen of a table of jam occurrence-related numerical values displayed on the display part of the user terminal in the fourth embodiment.

First, the administrator inputs the job information to the input section 1202 of the user terminal 120.

The controller 101 of the information processing apparatus 100 obtains the job information via the communication part 102, analyzes the job information by comparing it with the jam occurrence-related information currently stored in the information processing apparatus 100, and stores the analysis result.

The controller 101 of the information processing apparatus 100 outputs the analysis information on the job to the user terminal 120. When the analysis information on the job includes information on the sheet type, the sheet size or the like unsupported by the type of a printing apparatus(es) or a sheet feed tray(s), the user terminal 120 displays this information on the display part 1201.

Specifically, as illustrated in FIG. 11, the user terminal 120 displays, as a tip, the type of printing apparatus and the sheet feed tray having an unsupported sheet brand(s), sheet size(s) or the like, which hereinafter may be referred to as the “unsupported sheet feed tray”, by masking on the display part 1201.

In FIG. 11, it is understood that all of the sheet feed trays 1 to 6 included in the third printing apparatus 110C are unsupported sheet feed trays. It is also understood that the sheet feed tray 3 of the first printing apparatus 110A and the sheet feed tray 3 of the second printing apparatus 110B are unsupported sheet feed trays. The sheet feed tray 6 of the first printing apparatus 110A is displayed as a recommended tray by the jam nonoccurrence probabilities for the respective sheet types being enclosed by a thick frame.

### [5] Fifth Embodiment

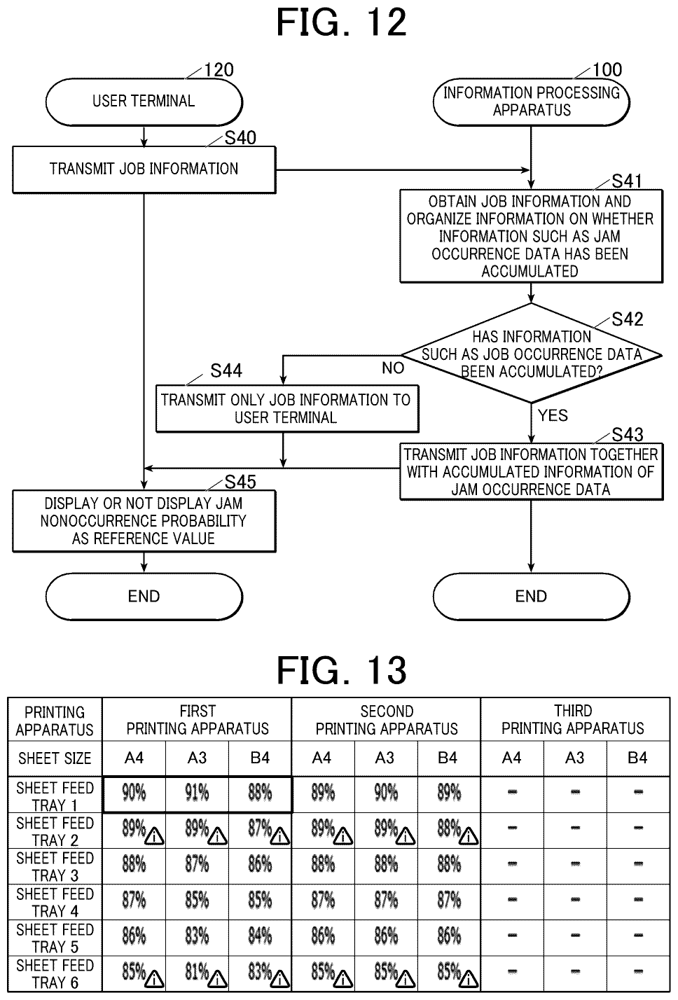

FIG. 12 illustrates an example of a flowchart illustrating the flow of a fifth embodiment.

If a printing company A having received a job order has just installed a printing apparatus(es), or started to handle a new sheet type, jam occurrence data related to each printing apparatus or sheet feed tray may have not been accumulated as information on the printing company A.

In this case, the jam occurrence data or the like regarding the same printing apparatus and/or sheet feed tray in a printing company B different from the printing company A, which has received a job order, may have been accumulated in the information processing apparatus 100. Then, the value(s) of the jam occurrence data can be used as a reference value(s).

The administrator of the printing company A inputs the job information to the input section 1202 of the user terminal 120.

In Step S40, the user terminal 120 transmits the job information to the information processing apparatus 100 via the communication part 1203.

In Step S41, the controller 101 of the information processing apparatus 100 obtains the job information. At the same time, the controller 101 determines whether the information such as the jam occurrence data regarding the same printing apparatus and/or sheet feed tray in the printing company B different from the printing company A, which has received a job order, has been accumulated in the information processing apparatus 100. In addition, the controller 101 organizes both the accumulated information of the jam occurrence data and the ordered job information. The “accumulated information of the jam occurrence data” includes the jam occurrence-related numerical values calculated from the jam occurrence data.

In Step S42, if the controller 101 determines that the information such as the jam occurrence data regarding the same printing apparatus and/or sheet feed tray in the printing company B different from the printing company A, which has received a job order, has been accumulated in the information processing apparatus 100, the process proceeds to Step S43. In Step S42, if the controller 101 determines that the information such as the jam occurrence data regarding the same printing apparatus and/or sheet feed tray in the printing company B different from the printing company A, which has received a job order, has not been accumulated in the information processing apparatus 100, the process proceeds to Step S44.

In Step S43, the controller 101 of the information processing apparatus 100 transmits the job information to the user terminal 120 via the communication part together with the accumulated information of the jam occurrence data. Then, the process proceeds to Step S45.

In Step S44, the controller 101 of the information processing apparatus 100 transmits only the job information to the user terminal 120 via the communication part 102. Then, the process proceeds to Step S45.

In Step S45, when the user terminal 120 receives the accumulated information, the user terminal 120 displays the accumulated information on the display part 1201, and displays the jam occurrence-related numerical values for the respective sheet feed trays of each printing apparatus as reference values. When the user terminal 120 does not receive the accumulated information of the jam occurrence data, the user terminal 120 displays no reference values on the display part 1201. The jam occurrence-related numerical value is, for example, the jam nonoccurrence probability.

### (Specific Example of Fifth Embodiment)

FIG. 13 illustrates an example of a display screen of a table of jam occurrence-related numerical values displayed on the display part of the user terminal in the fifth embodiment.

The user terminal 120 displays the reference values for the sheet feed trays of each printing apparatus on the display screen of the display part 1201 in their data display cells each provided with a mark of a triangle with an exclamation mark therein as illustrated in FIG. 13.

When the jam occurrence data or the like regarding the same printing apparatus and/or sheet feed tray in the printing company B different from the printing company A, which has received a job order, has not been accumulated in the information processing apparatus 100, as illustrated in FIG. 13, “-” is displayed on the display part 1201 of the user terminal 120. In FIG. 13, the sheet feed tray 1 of the first printing apparatus 110A is the recommended tray, and the jam nonoccurrence probabilities for the respective sheet types for the sheet feed tray 1 of the first printing apparatus 110A are displayed by being enclosed by a thick frame.

### [6] Others

Although in the above, embodiments of the present invention have been described and illustrated in detail, the disclosed embodiments are made for purposes illustration and example only of the information processing apparatus, the information display system and the program, and therefore the present invention is not limited thereto. Furthermore, the detailed configuration and the detailed operation of each component of the apparatus, the system, and the program may be appropriately modified without departing from the scope of the present invention. The scope of the present invention should be interpreted by terms of the appended claims.

What is claimed is:

1. An information processing apparatus comprising:
a hardware processor that obtains jam occurrence-related information from each of printing apparatuses, and, from the obtained jam occurrence-related information, calculates, for each sheet feed tray of each of the printing apparatuses, a jam occurrence-related numerical value; and
an outputter that outputs the calculated jam occurrence-related numerical value.

2. The information processing apparatus according to claim 1,
wherein the hardware processor calculates the jam occurrence-related numerical value for each sheet type, and
wherein the outputter outputs the calculated jam occurrence-related numerical value for each sheet type.

3. The information processing apparatus according to claim 2, wherein the sheet type includes one or more of a sheet quality, a basis weight and a size.

4. The information processing apparatus according to claim 1, wherein the jam occurrence-related information includes at least coverage information.

5. The information processing apparatus according to claim 1, wherein the jam occurrence-related information includes at least temperature-humidity information.

6. The information processing apparatus according to claim 1, wherein the outputter outputs a jam occurrence-related numerical value list.

7. The information processing apparatus according to claim 2,
wherein the hardware processor obtains a sheet type, and
wherein the outputter outputs the jam occurrence-related information analyzed by the hardware processor and the jam occurrence-related numerical value for the obtained sheet type.

8. An information display system comprising:
the information processing apparatus according to claim 1;
the printing apparatuses connected to the information processing apparatus and each including a sheet feed tray where a sheet is stored; and
a user terminal connected to the information processing apparatus and including a display,
wherein the user terminal switches jam occurrence-related numerical values, each of which is the jam occurrence-related numerical value, for the printing apparatuses to display, on the display, a jam occurrence-related numerical value of the jam occurrence-related numerical values for a printing apparatus of the printing apparatuses.

9. An information display system comprising:
the information processing apparatus according to claim 2;
the printing apparatuses connected to the information processing apparatus and each including a sheet feed tray where a sheet is stored; and
a user terminal connected to the information processing apparatus and including a display,
wherein the information processing apparatus outputs, to the user terminal, a sheet type candidate list in which jam occurrence-related numerical values, each of which is the jam occurrence-related numerical values, are arranged by sheet type, the sheet type candidate list being registered in advance, and
wherein the user terminal displays, on the display, the sheet type candidate list to present an option to a user.

10. An information display system comprising:
the information processing apparatus according to claim 1;
the printing apparatuses connected to the information processing apparatus and each including a sheet feed tray where a sheet is stored; and
a user terminal connected to the information processing apparatus and including a display,
wherein the information processing apparatus derives, from the calculated jam occurrence-related numerical value, a sheet feed tray that is unlikely to cause a jam, and outputs information on the sheet feed tray, and
wherein the user terminal displays, on the display, the information on the sheet feed tray that is unlikely to cause a jam to be recognized by a user.

11. An information display system comprising:
the information processing apparatus according to claim 1;
the printing apparatuses connected to the information processing apparatus and each including a sheet feed tray where a sheet is stored; and
a user terminal connected to the information processing apparatus and including a display,
wherein in response to the information processing apparatus analyzing the jam occurrence-related information and determining that a first sheet feed tray that is unlikely to cause a jam is present for a sheet type, but the first sheet feed tray being (i) already used for a job currently being subjected to a printing process or (ii) scheduled to be used for a job to be subjected to the printing process, the information processing apparatus outputs information on a second sheet feed tray that is unlikely to cause a jam next to the first sheet feed tray, and
wherein the user terminal displays, on the display, information on the second sheet feed tray.

12. An information display system comprising:
the information processing apparatus according to claim 1;
the printing apparatuses connected to the information processing apparatus and each including a sheet feed tray where a sheet is stored; and
a user terminal connected to the information processing apparatus and including a display,
wherein in response to a previously executed job being to be executed again, the information processing apparatus analyzes job information on the previously executed job, preferentially selects a printing apparatus and/or a sheet feed tray used for the previously executed job, and outputs information on the printing apparatus and/or the sheet feed tray, and
wherein the user terminal preferentially displays, on the display, the information on the printing apparatus and/or the sheet feed tray.

13. A non-transitory computer-readable storage medium storing a program causing a computer of an information processing apparatus to:
obtain jam occurrence-related information from each of printing apparatuses;
from the obtained jam occurrence-related information, calculate, for each sheet feed tray of each of the printing apparatuses, a jam occurrence-related numerical value; and
output the calculated jam occurrence-related numerical value.
